(19) United States
(12) Patent Application Publication
(10) Pub. No.: US 2008/0163231 A1
(43) Pub. Date: Jul. 3, 2008

(54) Method and system for geolocation assisted operations management

(76) Inventors: Thomas Bernard Breen, Broomall, PA (US); James Daniel Phelan, Paoli, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/646,672

(22) Filed: Dec. 28, 2006

(51) Int. Cl. G06F 9/50

(52) U.S. Cl. 718/104

(57) ABSTRACT

Provided are a method and system for providing a resource to a geolocated asset in need of the resource, comprising providing data of one or more providers of the resource including the location of the providers; determining that the asset needs the resource; locating the asset using the telematics device; correlating the asset location with the resource provider locations to determine a select resource provider; arranging for the asset to rendezvous with the select resource provider; and providing the resource to the asset.

### FIELD OF THE INVENTION

Provided is a system and method for using geolocation information to provide resources to the assets which need them, and more particularly to determining a preferred resource provider for a geolocated asset in need of a resource, and coordinating providing the resource to the asset.

### BACKGROUND OF THE INVENTION

Efficiently providing resources to assets that need them can be difficult to achieve. Providing resources can be fairly straightforward in an environment wherein there are few providers of resources and few assets that require them. However, the complexity of providing resources to assets increases as either or both of the number of resource providers and the number of assets increases. In an environment wherein there are many providers of resources, and/or many assets which need them, efficiently providing the assets with needed resources can be extremely challenging.

The use of telematics devices with geolocating ability on assets to keep track of the location of the assets is common, for example, among companies that have fleets of vehicles. Typically, each telematics device includes a locating unit that can determine the location of the asset using an existing geolocating system. The geolocating system is typically based on signals from satellites and/or from terrestrial sources. Typical signal sources are the GPS satellite system or cellular-based systems. In addition, such a telematics device can often communicate with a central station using either a satellite-based communications system or a cellular based communications system, such as to report its location. Such location information can be used for various purposes.

For example, U.S. Pat. No. 6,665,613 discloses a mobile asset, such as a vehicle, that can calculate a geofence based on its current location. Such a geofence can be used to detect unauthorized use of the vehicle, for example. U.S. Pat. No. 6,714,857 discloses the use of a remote monitoring system in conjunction with fuel consumption information to compute fuel consumption in various jurisdictions, for use in fuel tax calculations. U.S. Pat. No. 6,785,551 discloses use of vehicle geolocation to provide general information to the vehicle regarding its surroundings, such as traffic conditions and local points of interest. U.S. Pat. No. 6,982,656 discloses asset tracking and monitoring, but does not disclose efficiently providing the tracked asset with needed resources.

As noted, as the number of assets increases, the task of ensuring that each asset timely receives the resources it needs becomes more and more difficult. For example, in the case of a company managing a large fleet of trailers or other asset for transporting goods, an asset requiring periodic inspection in California may be located in Maine when its periodic inspection is due. The asset would then need to be transported to California to be inspected. It is desirable to avoid such inefficient dispatching. Another example is a refrigerated trailer in need of periodic maintenance of the refrigeration unit on a predetermined schedule. It is desirable to provide for such periodic maintenance as conveniently as possible. Or, if the refrigeration unit fails when the trailer is loaded and on the road, quickly and efficiently providing emergency maintenance to the unit can be difficult. It is desirable to provide for emergency maintenance with as little disruption to normal operations as possible.

Accordingly, there is a need for an improved method and system for efficiently ensuring assets receive the resources they need.

### BRIEF DESCRIPTION OF THE INVENTION

The present invention is directed to a method of providing resources to geolocated assets which substantially obviates one or more of the problems associated with limitations and disadvantages of the related art. The present invention provides a method and system for determining that an asset needs a resource, locating the asset, determining possible resource providers, selecting a preferred provider, and arranging for the asset to rendezvous with the selected provider so the asset can efficiently receive the needed resource.

In illustrative implementations of the present invention, equipment to determine that the asset needs a resource can be located at the asset or at a central station. The need for a resource can be determined based on a sensed asset parameter, or can be time-dependent. Equipment to select a preferred resource provider can be located at the asset or at the central station. The preferred resource provider can be selected based on the resource provider locations. Resource provider locations can be stored in a database, and/or can be determined based on geofences associated with the resource providers, and/or tracking devices associated with the resource providers. In exemplary implementations, the asset can be mobile and can be directed to rendezvous with selected provider, or the asset can be stationary and a selected provider can be directed to rendezvous with the asset, or both the asset and the provider can be mobile, and both directed to a selected rendezvous point. After the asset receives the needed resource, the asset or the resource provider can confirm to the central station that the resource was received. Resource-related asset information can also be updated.

Additional features and advantages of the invention will be set forth in the description which follows. Other advantages of the invention will be realized and attained by the structure particularly pointed out in the written description and claims hereof as well as the appended drawings.

It is to be understood that both the foregoing general description and the following detailed description are exemplary and explanatory and are not intended to be limiting, but are merely intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram showing an exemplary method of providing a needed resource to a geolocated asset, in accordance with an embodiment of the present invention.

FIG. 2 is a block diagram of an exemplary system for providing a geolocated asset with a needed resource, in accordance with an embodiment of the present invention.

### DETAILED DESCRIPTION OF THE INVENTION

Reference will now be made in detail to illustrative examples of the present invention, example of which is illustrated in the accompanying drawings.

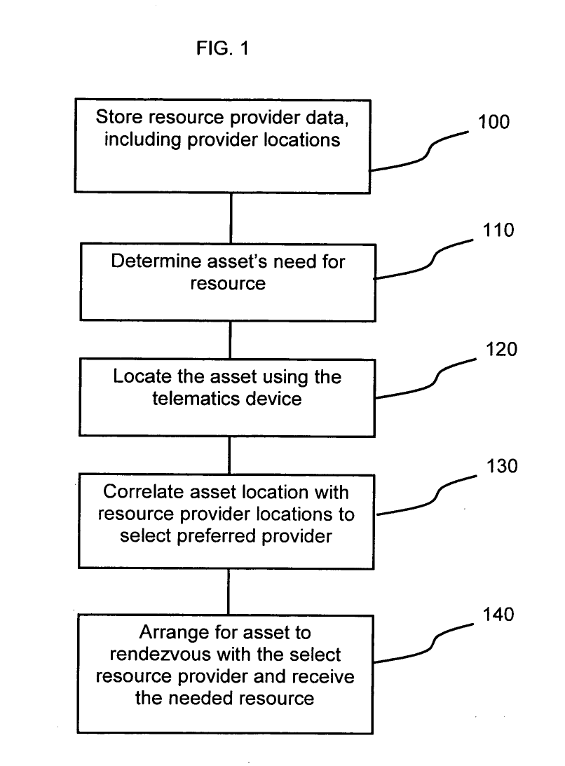

FIG. 1 shows a block diagram of an exemplary method of providing a needed resource to an asset having a telematics device, in accordance with the present invention. Resource provider data is provided (100), including the provider locations. The asset's need for a resource is determined (110). The asset is located using a telematics device associated with the asset (120). The asset location is correlated with the resource provider locations to determine a select resource provider (130). A rendezvous of the asset with the resource provider is arranged, and the resource is provided to the asset (140).

Resource provider data is provided (100), including the provider location. Resource provider data can be provided, for example, by populating a resource provider database. Such a database can be stored at a central location like a central station, or it can be stored on the asset. Any type of data storage device can be used to store the provider data. Typical data storage devices include hard drives and non-volatile memory, but it will be appreciated that other types of data storage devices can also be used, such as optical storage. Resource provider location information can comprise geofences associated with the providers. The geofences can indicate a resource provider's location with varying degrees of specificity. For example, a geofence can indicate the physical boundary of a resource provider, such as an inspection station. In another example, a geofence can indicate an area within which a resource can be provided, such as a service area of a service provider. In an exemplary implementation, the location of a resource provider within a geofence can be further enhanced by the resource provider using a telematics device to determine its location using signals of an existing geolocation system, such as to locate a particular tow truck location within a tow service provider's designated service area.

The asset's need for a resource is also determined (110). The asset's need for a resource can be determined by one or more sensors, or combinations of sensors. A sensor can detect any asset parameter that can indicate a need for a resource. For example, a sensor reading or a signal from a sensor can be compared with a threshold value. A need for a resource can be indicated if the parameter crosses above or below a predetermined threshold, or falls inside or outside of a predetermined range. Sensed asset-related parameters can include one or more of a fluid level, pressure, weight, volume, voltage, current, resistance, electrical or physical contact, temperature, vibration, noise, shock, angle, acceleration, and deceleration, for example, rapid deceleration. For example, a sensor inside a refrigerated compartment can detect that the temperature inside the compartment has crossed a maximum threshold and is too high, which can indicate a need for a service resource for maintenance of the refrigeration unit. In exemplary implementations, sensed asset parameters can be used to indicate a need for resources such as fuel or other fluid in a tank, air in a tire, coolant in a cooling system, lamp replacement, wheel and/or axle repair, and a need for unscheduled maintenance.

Alternatively, in exemplary implementations, the need for a resource can be time dependent. The need for the resource can be determined or tolled by the occurrence of an event, or by the lapse of a certain amount of time since a past event, or the approach within a certain amount of time to a future event. For example, the needed resource can be an inspection station, and the need for an inspection can be determined by the date of the next scheduled inspection or the time elapsed since the last inspection. In exemplary implementations, the time-dependent needed resource can be associated with acquiring or renewing a license, or a scheduled inspection, or scheduled maintenance. It will be appreciated that other types of scheduled events can determine or toll the need for a resource. The time dependent resource needs can be stored in a database, such as an issue date and/or an expiration date of a license, an inspection, or the schedule for performing maintenance, such as to ensure compliance with warranty requirements. Where the need for the resource is time dependent, a device for keeping track of time or of elapsed time can be provided, such as a clock, timer, or other timekeeper, and used to indicate an asset's need for the time-dependent resource.

The asset's location is determined using a telematics device associated with the asset (120). In an exemplary implementation, the telematics device determines the asset location using signals of an existing geolocation system. Such signals can be from satellites and/or from terrestrial sources. A common geolocation system is the global positioning system (GPS). Other geolocating systems can use terrestrial signals such as cellular communication signals.

The asset location is correlated with the resource provider locations to determine a select resource provider (130). In an exemplary implementation, the correlation can be accomplished by calculating the distance from the location of the asset to the known locations of providers of the needed resource stored in the database. If there are multiple resource providers, the resource provider nearest to the asset can be selected. In exemplary implementations, additional factors can be included in determining a select provider, such as the mobility of the asset and/or the resource providers, the costs associated with various providers for providing the resource, or contractual arrangements having resource delivery requirements, etc. In an exemplary implementation, the asset location can be correlated with the nearest provider by the asset detecting a geofence associated with the provider. For example, a geofence can indicate a service territory of a service provider. Geofence information can be provided to the asset from the central station, or it can be stored with the asset.

The correlation of the asset location with the resource provider locations, and/or the selection of a preferred provider, can be performed by a processor at the central station, or by a processor associated with the asset. In an exemplary implementation, the central station is notified of the asset's location and that the asset needs a resource, and a processor at the central station determines the preferred resource provider.

A rendezvous between the asset and the resource provider is arranged, and the resource is provided to the asset (140). In exemplary implementations, a preferred rendezvous location is determined, and at least one of the resource and the asset are directed to the preferred location. For example, if the asset is mobile and the resource provider is stationary, the asset can be directed to rendezvous with the resource provider at its location. In an exemplary implementation, the asset can comprise a trailer pulled by a tractor, the trailer needing a scheduled inspection, and the tractor can be directed to pull the trailer to the nearest inspection station. In another exemplary implementation, the asset is stationary and the resource is mobile, and the resource provider can be directed to rendezvous with the asset. For example, if a delivery truck has broken down, a service provider can be dispatched to provide repairs. If both the asset and the resource provider are mobile, the asset and the resource provider can both be directed to a preferred rendezvous point. For example, if a tractor is pulling a refrigerated trailer in which the refrigerated unit has failed, the tractor and a service provider with a replacement unit can both be directed to a rendezvous location at a point between the two, such as a truck stop, or a particular mile marker on a highway. In this way, the replacement unit can be provided to the trailer with a minimum of delay, reducing the likelihood of damage to the refrigerated cargo.

In an exemplary implementation, after the resource is provided to the asset, the asset or the resource provider can provide a confirmation to the central station that the asset has received the resource. An asset database can be stored at the asset or at a central station, and the database can be updated when the asset has received the resource.

The method and system of the present invention can be used in a wide variety of situations, as will be apparent to those of skill in the art. For example, the tracked assets can be facilities in an office building such as computer, electrical distribution, environmental control, or other equipment, and the resource provider can be a repair or maintenance operator. An asset sensing a need for maintenance or repair can send a signal with its location and an indication of its resource need to a central station; or, the central station can keep records of the maintenance schedule of the equipment and can determine when scheduled maintenance is needed. The central station can respond to a need for repair or maintenance by determining a preferred service provider, and sending a communication to the preferred service provider. The service provider can receive the communication, rendezvous with the asset, and provide the needed repair or maintenance to the asset. The asset or the service provider can then send confirmation to the central station that the required service has been provided.

In exemplary implementations, one or more of the steps of the present invention can be accomplished automatically, with little or no human intervention, such as by being directed by a computer system controlled by appropriate software. For example, one or more of sensing an asset parameter, determining the parameter has crossed a predetermined threshold, determining a need for service, locating the asset using a telematics device, correlating the asset location with predetermined service provider locations, selecting a preferred service provider, sending a communication to the selected provider, receiving confirmation that the asset received the needed service, and updating asset data can be accomplished automatically.

In an exemplary implementation, the present invention can also provide for the telematics device to send to the central station a message if the needed resource was not successfully received, such as within an expected time period. If the asset has not received the needed resource within a predetermined period of time from the determination that the asset needs the resource, the asset can send a message to the central system to indicate the resource has not been received. The central station can then contact the resource provider for updated information, and/or can contact a second resource provider if needed.

Importantly, the method shown in FIG. 1 is equally applicable to operating environments having a plurality of tracked assets having telematics devices, each asset having a need or a potential need for a plurality of different resources or types of resources, and/or having a plurality of resource providers for each different resource. In systems having a plurality of telematics devices, each telematics device can have a unique identifier, which it transmits to the central station each time it communicates with it. This allows the central station to keep track of which assets associated with those telematics devices have which resource needs, and allows the central station to direct communications and resources to a particular asset associated with a particular telematics device. In addition, in systems having telematics devices that are widely dispersed, the central station may be able to coordinate the provision of needed resources to multiple assets.

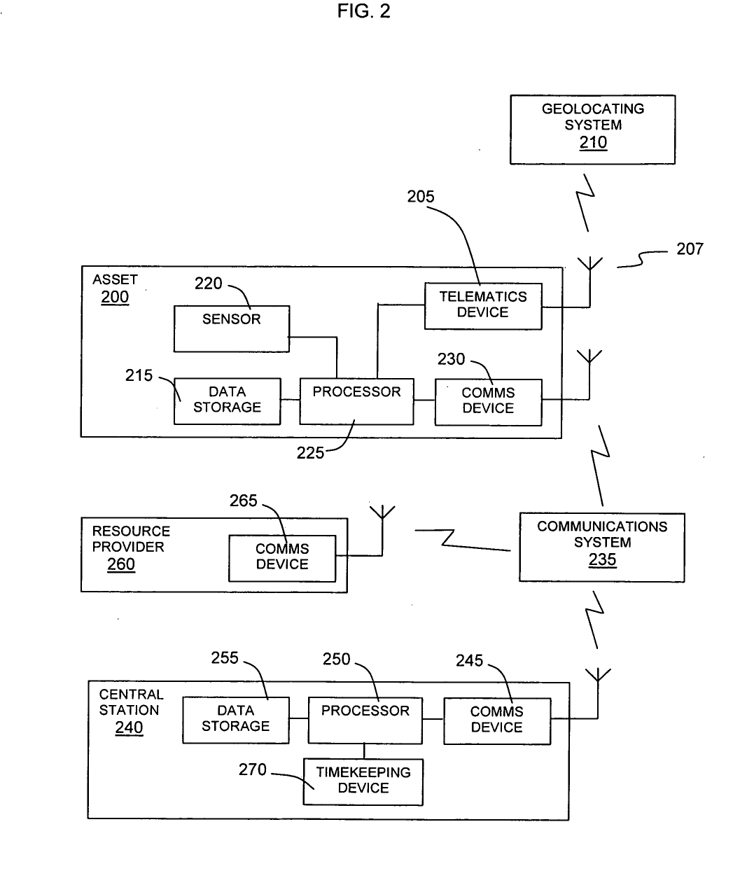

FIG. 2 is a block diagram showing an exemplary implementation of a system for providing a resource to an asset, in accordance with the present invention. Asset 200 is physically associated with a geolocating telematics device 205, such as by installing the device on the asset. The telematics device 205 determines the location of the asset 200 using a geolocating system 210. The asset 200 is provided with a data storage device 215, sensor 220, processor 225, and communications device 230. The asset 200 can also be provided with a timekeeper (not shown). The communications device 230 communicates with central station 240 using communications system 235. Central station 240 is provided with communications device 245, processor 250, data storage device 255, and timekeeper 270. Central station 240 communicates with resource provider 260 using communications system 235. Resource provider 260 is provided with communications device 265.

Asset 200 is physically associated with a geolocating telematics device 205, such as by installing the device on the asset. Asset 200 can be any type of asset with a current or potential need to receive any type of resource. For example, asset 200 can be a mobile asset, such as a vehicle, a trailer, or a tractor-trailer. Asset 200 can also be a stationary asset. For example, asset 200 can be part of an electric distribution system, such as a distribution transformer; or part of an environmental control system, such as an air conditioning unit; or part of a computer system, such as a server.

The telematics device 205 determines the location of the asset using a geolocating system 210. Telematics device 205 is a position determining device that works in conjunction with geolocating system 210, such as the Global Positioning System (GPS), Differential GPS (DGPS), Eurofix DGPS, or the Global Navigation Satellite System (GLONASS). Importantly, the present invention can use any position determining system (terrestrial and/or satellite based), and is not dependent on the use of a particular system. Telematics device 205 can receive signals through antenna 207 from external geolocation references such as satellites or cellular towers (not shown) which are part of the geolocation system 210, from which it determines the location of the asset.

In an exemplary implementation, the asset is provided with a data storage device 215. Data storage device 215 can be any type of device capable of storing and/or updating data, such as at least one hard drive or other magnetic storage device, non-volatile RAM or other solid state device, CD or DVD or other optical device, or any other type of data storage.

The asset is provided with at least one sensor 220 for sensing at least one asset parameter and providing an indication of the parameter. The parameter can comprise at least one of fluid level, pressure, weight, volume, voltage, current, resistance, physical or electrical contact, temperature, or any other type of asset parameter that can be sensed.

The asset is provided with processor 225 linked to sensor 220. Processor 225 can receive the asset parameter indication from the sensor and compare it to a threshold value, such as a minimum or maximum permissible value, or the bottom or top of an acceptable operating range, for example. The threshold values and/or ranges can be stored in data storage 215. Crossing a threshold value, or departing from an acceptable range, can indicate that a resource is needed by the asset. If the threshold value is crossed or the acceptable range is departed from, the processor can cause a signal to be sent indicating a need for a resource associated with the sensed parameter, as well as the location of the asset, as determined from telematics device 205.

The asset is provided with communications device 230 linked to processor 225. Communications device 230 can communicate using communications system 235, which can include any appropriate type of wired or wireless communications system. In an exemplary implementation, communications device 230 sends the signal indicating a need for a resource to a central station 240 using communications system 235.

Central station 240 is provided with communications device 245, which receives the signal from the asset indicating its need for a resource. Central station 240 is also provided with processor 250, data storage device 255, and timekeeping device 270. In an exemplary implementation, the data storage device 255 can store data of one or more providers of one or more resources that are used by asset 200. The data includes the locations of the resource providers. Data storage device 255 can also store asset information, such as the asset's resource needs, and whether or not a resource was received.

Processor 250 can correlate the location of the asset needing the resource with the known locations of resource providers stored in data storage 255. A preferred resource provider can be selected by processor 250 of central station 240 based on the asset and resource provider location information, such as by determining the distance from the asset location to each of the providers of the needed resource, and selecting the resource provider closest to the asset. In exemplary implementations, other criteria can be used by the processor in addition to proximity to select the preferred resource provider, such as the mobility of the asset and/or the resource providers, the cost of the resource from different providers, contractual arrangements, and/or the time sensitivity of the need for the resource.

In an exemplary implementation, such as in the case wherein the asset is stationary and the resource provider is mobile, when a preferred provider has been selected, central station 240 can send a communication to selected resource provider 260 provided with communications device 265, using communications system 235. Communications device 265 can be a phone, pager, PDA, or any other appropriate communications device, and the communication can comprise a phone call, text message, page, or any other appropriate type of communication. The communication can indicate the need for a resource, and the location of the asset needing the resource. The resource provider 260 can then rendezvous with the asset and provide the needed resource. In another exemplary implementation, such as in the case wherein the asset is mobile and the resource provider is stationary, when a preferred provider has been selected, central station 240 can send a communication to the asset directing the asset to rendezvous with the preferred resource provider 260 at its location. The asset can then travel to the selected resource provider 260 and receive the needed resource. In yet another exemplary implementation, both the asset and the preferred resource provider are mobile. Communications can be sent by central station 240 to both the asset and the selected resource provider directing them to a preferred rendezvous point, where the asset can receive the needed resource. Central station data storage device 255 can include the locations of possible rendezvous points, such as highway mile markers, truck stops, and/or rest areas. In order to determine the preferred rendezvous point, central station processor 250 can correlate the location of the asset, the resource providers, and possible rendezvous points and select a preferred rendezvous point, such as by minimizing the total distance from each of the resource and the asset to the rendezvous point, although other criteria can also be used.

As described above, sensor 220 and processor 225 of asset 200 can work together to form a resource need indicator for indicating that the asset needs the resource. Other resource need indicators are also possible. For example, a need for a resource may be time dependent, such as a need for an inspection, an initial license and/or tag issuance or renewal, or maintenance, at regular or irregular intervals. In an exemplary implementation, a resource need indicator can comprise a central station 240 data storage device 255 for storing time-dependent asset information, a timekeeper 270 operatively associated with the asset, and a processor 250 or other comparer operatively associated with the data storage device 255 and the timekeeper 270 for comparing the current time and/or the time elapsed since a past event with the time-dependent asset information. For example, an inspection of the asset may be required by a particular date, or it may be required within a certain amount of time, such as a year from the previous inspection, or within a particular time interval, such as in the month of June. The timekeeper 270 can determine the date or the amount of time since the last inspection or some other relevant event. Based on the time-dependent data and the time kept by the timekeeper 270, the processor 250 can determine whether there is a need for a time-dependent resource, such as a need for an inspection whose due date is approaching. If so, it can generate a signal indicating a need for the resource, here, an inspection station where the inspection can be performed.

In exemplary implementations, the data storage device for storing data of resource providers, asset information, and/or time dependent asset information can be located at either the asset 200, or at central station 240. The processor acting as a location correlator can also be located at either the asset 200 or at central station 240. In an exemplary implementation, the data storage, resource need indicator and location correlator can all be located at asset 200, and the asset can generate a message indicating its need for a resource and determine a preferred resource provider. In exemplary implementations, the asset can then direct itself to the preferred resource provider, or send a message to the provider, or select a preferred rendezvous point and direct itself and the provider to the selected rendezvous point, without involving a central station.

In exemplary implementations, when the asset receives the needed resource, it can update its own data storage containing asset information, or can send a message to the central station confirming receipt of the resource so that the central station can update its asset-related information. Alternatively, the resource provider can send a message to the central station confirming that it delivered the resource to the asset.

In exemplary implementations, information of geofences operatively associated with resource providers can be stored in asset data storage at the asset or at a central station. A processor at the asset or at the central station can act as a geofence detector for detecting geofences when the asset is in the proximity of a provider of a needed resource, and can use the geofence information when selecting a preferred resource provider.

In exemplary implementations, one or more of telematics device 205, data storage 215, processor 225, sensor 220 and communications device 230 at the asset can be part of or integrated within a single package. Processor 225 can be part of an embedded device (e.g., an onboard computer with limited functionality) or can be a general use processor. Similarly, in exemplary implementations, communications device 245, processor 250, data storage 255 and timekeeper 270 at the central station can be part of or integrated within a single package.

It will be apparent to those skilled in the art that various modifications and variation can be made in the method and system of the present invention without departing from the spirit or scope of the invention. Thus, it is intended that the present invention cover the modifications and variations of this invention provided they come within the scope of the appended claims and their equivalents.

What is claimed is:

1. A method of providing a resource to an asset having a geolocating telematics device, the method comprising:
providing data of one or more providers of the resource, the data comprising the location of the providers;
determining that the asset needs the resource;
locating the asset using the telematics device;
correlating the asset location with the resource provider locations to determine a select resource provider;
arranging for the asset to rendezvous with the select resource provider; and
providing the resource to the asset.

2. The method of claim 1, wherein the step of determining that the asset needs the resource comprises:
receiving data from a sensor that senses a parameter of the asset;
comparing the received sensor data with a threshold value; and
determining that the asset needs the resource when the received sensor data crosses the threshold value.

3. The method of claim 2, wherein the sensed asset parameter is one of the group consisting of: fluid level, pressure, weight, volume, voltage, current, resistance, physical contact, electrical contact, temperature, vibration, noise, shock, angle, acceleration, and deceleration.

4. The method of claim 3, wherein the needed resource is one of the group consisting of: fuel in a tank, air in a tire, coolant in a cooling system, lamp replacement, tire repair, axle repair, and unscheduled maintenance.

5. The method of claim 1, wherein the asset's need for the resource is time dependent, and the step of determining the asset needs the resource comprises:
storing time dependent resource needs
keeping track of the passage of time; and
determining that the asset needs the resource occurs upon one of:
the occurrence of an event
the lapse of a certain amount of time since a past event; and
the approach within a certain amount of time to future event.

6. The method of claim 5, wherein the needed resource is one of the group consisting of: a license issuance, a license renewal, a tag issuance, a tag renewal, a scheduled inspection, and the performance of scheduled maintenance.

7. The method of claim 1, wherein the geolocating telematics device determines the location of the asset using at least one of satellite signals and terrestrial signals of a geolocation system.

8. The method of claim 1, wherein the step of correlating the asset location with the resource provider occurs by the asset detecting a geofence associated with the resource provider.

9. The method of claim 1, wherein the step of correlating the asset location with the resource provider is performed by a processor at a central station.

10. The method of claim 1, further comprising:
after the locating the asset step,
notifying a central station of the asset's location and that the asset needs a resource.

11. The method of claim 10, wherein the step of arranging for the rendezvous comprises:
determining a preferred rendezvous location; and
directing at least one of the resource and the asset to the preferred rendezvous location.

12. The method of claim 10, further comprising:
after the providing the resource step,
confirming to the central station that the asset has received the resource.

13. A system for providing a resource to an asset, the system comprising:
a geolocating telematics device operatively associated with the asset for determining the location of the asset using a geolocating system;
a data storage device for storing data of one or more providers of the resource, the data comprising locations of the providers;
a resource need indicator, for indicating that the asset needs the resource;
a location correlator operatively associated with the telematics device, the data storage device, and the resource need indicator, for receiving the resource need indication and correlating the asset location with the resource provider locations and selecting a preferred resource provider; and
a communication device operatively associated with the location correlator for communicating an instruction to at least one of the asset and the resource provider to rendezvous with the other of the asset and the resource provider so that the asset can be provided with the needed resource.

14. The system of claim 13, wherein the resource need indicator comprises:
a sensor operatively associated with the asset for sensing a parameter of the asset; and
a comparer for comparing the sensor data with a threshold value.

15. The system of claim 13, wherein the resource need indicator comprises:
a time data storage device for storing time-dependent asset information;
a timekeeper operatively associated with the time data storage device; and
a comparer operatively associated with the time data storage device and the timekeeper for comparing at least one of the current time and the time elapsed since a past event with the time-dependent asset information.

16. The system of claim 13, further comprising:
a geofence operatively associated with the resource provider for indicating proximity to the resource provider; and
a geofence detector for detecting the geofence when the asset is in the proximity of the resource,
whereby the preferred resource provider is selected.

17. The system of claim 13, wherein the correlator is located at a central station, the system further comprising:
a transmitter operatively associated with the asset for sending to the central station a notification that the asset needs a resource and the asset's location;
a receiver at the central station for receiving the notification;
a transmitter at the central station for sending an instruction to at least one of the resource provider and the asset to proceed to a preferred rendezvous point to provide the resource to the asset; and
a receiver at at least one of the asset and the preferred resource provider for receiving the instruction.
